(19) United States
(12) Patent Application Publication
(10) Pub. No.: US 2013/0185099 A1
(43) Pub. Date: Jul. 18, 2013

(54) MEDICAL QUERY REFINEMENT SYSTEM

(71) Applicants: Anca Ioana Daniela Bucur, Eindhoven (NL); Richard Vdovjak, Eindhoven (NL); Jasper Johannes Adrianus Van Leeuwen, Eindhoven (NL)

(72) Inventors: Anca Ioana Daniela Bucur, Eindhoven (NL); Richard Vdovjak, Eindhoven (NL); Jasper Johannes Adrianus Van Leeuwen, Eindhoven (NL)

(73) Assignee: KONINKLIJKE PHILIPS ELECTRONICS N.V., EINDHOVEN (NL)

(21) Appl. No.: 13/876,950

(22) PCT Filed: Sep. 22, 2011
(86) PCT No.: PCT/IB2011/054173

§ 371 Date: Mar. 29, 2013

(30) Foreign Application Priority Data
Sep. 30, 2010 (EP) 10183108.9

(51) Int. Cl. G06Q 10/06; G06Q 50/22

(52) U.S. Cl. CPC G06Q 10/06; G06Q 50/22
USPC 705/3; 705/2

(57) ABSTRACT

A system (100) for generating a refined medical query from a user medical query, the user medical query comprising a user medical term, and the system comprising an input (110) for receiving the user medical query from a user, an access controller (120) for accessing a medical guideline file (121) and a rules repository (122), the medical guideline file (121) comprising a medical information item, and the rules repository (122) comprising a rule linking the medical information item to the user medical term, and a query refiner (130) for generating the refined medical query from the user medical query by including the medical information item in the refined medical query and for providing the refined medical query to a search engine (140).

### FIELD OF THE INVENTION

The invention relates to a system for and a method of generating a refined medical query from a user's medical query.

### BACKGROUND OF THE INVENTION

In the medical domain, decision support systems are commonly used to assist clinicians in making medical decisions. The clinician may interact with such a system by providing a query to the system. In turn, the system may use medical data to generate a response. The medical data may be patient data, resulting in a patient-specific response. Therefore, the system may be able to assist the clinician by providing a patient-specific response.

Decision support systems may also be used by patients themselves to obtain information or make decisions about their health. The system thus provides an alternative to the clinician who may not always be available to personally provide such assistance.

As part of providing a response to a user's query, the user's query may be refined to generate a refined query. A publication from the domain of internet search engines, “Knowledge Agents on the Web”, by Y. Aridor et al., Proceedings of the 4^{th} International Workshop on Cooperative Information Agents, July 2000, Boston, USA, discloses using an agent situated between the user and a search engine. Queries of the user are refined by the agent by adding to each of the terms of the query its most notable lexical affinities. These affinities have been found by the agent by extracting relevant information from previous searches. The refined queries are sent to general purpose search engines. Furthermore, the resulting search results are ranked based on the agent's domain specific knowledge.

### SUMMARY OF THE INVENTION

It would be advantageous to have an improved device or method for generating a refined medical query from a user's medical query.

To better address this concern, a first aspect of the invention provides a system for generating a refined medical query from a user medical query, the user medical query comprising a user medical term, and the system comprising an input for receiving the user medical query from a user, an access controller for accessing a medical guideline file and a rules repository, the medical guideline file comprising a medical information item, and the rules repository comprising a rule linking the medical information item to the user medical term, and a query refiner for generating the refined medical query from the user medical query by including the medical information item in the refined medical query and for providing the refined medical query to a search engine.

The measures according to the invention have the effect that a user can provide a user medical query, i.e., a user's medical query, containing a user medical term, i.e., a medical term within the user medical query, to the system. The system refines the user medical query for providing a refined medical query to a search engine.

The refinement of the user medical query is performed as follows.

The system has access to a medical guideline file, i.e., a computer accessible version of a medical guideline or medical protocol, henceforth commonly referred to as medical guideline. Medical guidelines provide guidance to clinicians regarding the diagnosis and treatment within a specific medical domain. For that purpose, a medical guideline comprises medical information items containing non-patient specific medical terms or concepts, such as clinical questions, decision options and their outcomes. These are based on manually selected, highest quality evidence and data. A medical guideline is therefore an authoritative source of medical information.

The system also has access to a rules repository, which contains a rule linking the user medical term from the user medical query to a medical information item in the medical guideline file. The system can therefore obtain the medical information item that is related to the user medical term. The system then refines the user medical query by including the medical information item in the refined medical query. The refined medical query may be provided to a search engine to obtain a search result.

Consequently, the above system provides a medical query that is refined using a medical guideline, and thus is refined using an authoritative source of medical information. Advantageously, a clinician does not need to manually consult a medical guideline, refine his query, and then submit the refined and possibly long query to a search engine. Advantageously, a patient does not need to be aware of medical guidelines, but may nevertheless be provided with search results that reflect a query refined using said guidelines.

Advantageously, the system may address a need in the healthcare domain of retrieving and aggregating information that suits complex information goals. It may be used, e.g., in a clinical decision support system to support the clinicians in improving the efficiency of their work, reduce errors, and improve the patient outcome. The need may be addressed by automatically refining the user medical query.

Optionally, the query refiner may be configured for searching for the user medical term in the rules repository to obtain the rule linking the medical information item to the user medical term.

By searching the rules repository for the user medical term, a rule is found that links the user medical term to a particular medical information item. The particular medical information item is then used to refine the user medical query.

The query refiner may be configured for including the medical information item in the refined medical query by replacing the user medical term in the user medical query with the medical information item to obtain the refined medical query.

By replacing the user medical term in the user medical query with the particular medical information item, a more specific medical query is obtained. Advantageously, a more specific medical query yields more relevant search results.

The access controller may be configured for accessing a medical ontology, the medical ontology comprising the user medical term and an ontology medical term that is linked to the user medical term, and wherein the query refiner is configured for searching for the user medical term in the medical ontology to obtain the ontology medical term, searching for the ontology medical term in the rules repository to obtain a rule linking a further medical information item to the ontology medical term, and including the further medical information item in the refined medical query.

A medical ontology is a formal representation of the medical terms within a medical domain and of the relationships between those terms. For that purpose, the medical ontology comprises a set of medical terms and their logical connection, i.e., their relationship. By searching the medical ontology for the user medical term from the user medical query, the system is able to obtain an ontology medical term that is logically connected, and thus typically conceptually related, to the user medical term.

The rules repository is used to find a further medical information item that is related to the ontology medical term. The further medical information item is then included in the refined medical query. As such, a user medical term may be replaced or expanded using a conceptually related ontology medical term, which is then used to search the medical guideline file. As an example, the medical term ‘breast cancer’ may be replaced or expanded with the related term ‘in situ breast cancer’, which is then used to search the medical guideline file for relevant medical information items.

Advantageously, a medical term provided by the user is automatically refined using a medical ontology, and subsequently refined using the medical guideline file. The refinement may broaden the medical query if the ontology medical term is a broader medical term. The refinement may narrow the medical query if the ontology medical term is a more specific medical term. Advantageously, a patient does not need to be aware of medical terms within a particular medical domain, but is nevertheless provided with search results that reflect a query refined using said medical terms.

The access controller may be configured for accessing a patient data file, the patient data file comprising the medical information item and a patient information item linked to the medical information item, and the query refiner may be configured for searching for the medical information item in the patient data file to obtain the patient information item, and including the patient information item in the refined medical query.

A patient data file is a computer accessible version of a collection of health information of a particular patient, and is also commonly referred to as electronic patient record or computerized patient record. The patient data file typically comprises medical information items and patient information items linked thereto. The medical information items are non-patient specific medical terms or concepts, whereas the patient information items are patient-specific items such as, e.g., measurement values. For example, the patient data file may comprise the medical information item of “blood glucose level”, and, as patient information item related thereto, a measured value of 4.2 mmol/L.

The medical query is refined using a patient information item from the patient data file. For that purpose, the patient data file is searched for the patient information item that is related to the medical information item. Thus, the query is initially refined using a medical guideline file, i.e., an authoritative source of medical information, and then a medical information item from the medical guideline file is used to find the patient data related thereto.

Advantageously, a clinician does not need to manually consult the patient data file to submit a query using actual patient data. Advantageously, a patient does not need to be aware of his or her actual patient data, but is nevertheless provided with search results that reflect a query refined using said patient data. Advantageously, when the medical information item is a medical decision point, the medical decision point may be automatically completed and/or evaluated using the actual patient data.

The access controller may be configured for accessing an attention trail file, the attention trail file comprising an attention information item indicative of a usage of the system by the user, and the query refiner may be configured for including the medical information item in the refined medical query in dependence on the attention information item.

An attention trail is a collection of information items that describe a user's usage of a system. For example, the attention trail may include information items relating to the user's previous queries, the search results that were read, the search results that were not read, the user's own notes, etc. Hence, the attention trail may be indicative of the user's interest. The attention trail may be collected by, e.g., a monitoring module, that has access to the input and the output of the system and captures said information. Means for collecting an attention trail are known from, e.g., internet search engines that capture the user's previous queries to provide improved search results.

Accordingly, the user's attention trail is used to refine the user medical query. For that purpose, an attention information item from a computer accessible version of the attention trail, i.e., an attention trail file, is used to refine the user medical query. Advantageously, the query is refined in accordance with the user's interests. Advantageously, search results are provided that reflect the user's interests.

The system may further comprise the search engine for searching for the refined medical query in a medical data repository to obtain a search result, and an output for providing the search result to the user.

By providing the refined medical query to the search engine and by providing the search result to the user, the user is provided with a response to his query.

The medical data repository may comprise a plurality of medical sources, the search engine may comprise a rank manager for accessing a plurality of ranks associated with the plurality of medical sources, the search engine may be configured for searching for the refined medical query in the plurality of medical sources to obtain a plurality of search results, selecting at least one of the plurality of search results in dependence on the plurality of ranks, and the output may be configured for providing the at least one of the plurality of search results to the user.

The search engine searches a plurality of medical sources, while additionally obtaining a plurality of ranks associated with said sources from the rank manager. The plurality of ranks is used to determine which of the plurality of search results are to be provided to the user as the response to the medical query. The plurality of ranks may be indicative of, e.g., the medical reliability, relevance, or age.

Therefore, the search engine may determine which ones of the search results may be most relevant to the user. Advantageously, the search engine is not dependent on the search results themselves to identify their relevance. Advantageously, the relevance of the search result that is provided to the user is improved.

The search engine may further comprise a receiver for receiving from an expert in a medical field of the medical query at least one of the plurality of medical sources and/or at least one of the plurality of ranks.

Accordingly, a particular medical source is searched that is provided by an expert in the medical field of the medical query, and/or a rank for a particular medical source is provided by said expert. Advantageously, a user may obtain relevant search results without personally having to consult the expert regarding the current medical query. Advantageously, medical sources are used that are considered to be relevant by the expert, or a relatively high rank is provided for said sources by the expert.

The at least one of the plurality of medical sources and/or the at least one of the plurality of ranks may be provided by the expert using a usage monitor for monitoring a usage of the plurality of medical sources by the expert.

A usage monitor may be implemented by, e.g., a software program installed on a workstation or computer of the expert. By monitoring a usage of the plurality of medical sources by the expert, it is possible to automatically obtain information on the relevance of said medical sources, without requiring additional, e.g., manual, input from the expert. The usage monitor may provide either a source consulted by the expert, or a ranking associated with said source. The ranking may be determined by, e.g., monitoring the frequency of consultation of said source. Advantageously, a relatively simple and convenient way is provided to obtain the at least one of the plurality of medical sources and/or the at least one of the plurality of ranks from the expert.

A workstation may comprise the system set forth.

A method of generating a refined medical query from a user medical query, the user medical query comprising a user medical term, may comprise receiving the user medical query from a user, accessing a medical guideline file and a rules repository, the medical guideline file comprising a medical information item, and the rules repository comprising a rule linking the medical information item to the user medical term, generating the refined medical query from the user medical query by including the medical information item in the refined medical query, and providing the refined medical query to a search engine.

A computer program product may comprise instructions for causing a processor system to perform the method set forth.

The medical guideline file may comprise an additional medical information item, and the query refiner may be configured for generating an additional refined medical query from the user medical query by including the additional medical information item in the additional refined medical query, the search engine may be configured for searching for the additional refined medical query in the medical data repository to obtain an additional search result, and the output may be configured for providing at least one of: the search result and the additional search result to the user.

The query refiner generates an additional refined medical query next to the original refined medical query. The additional refined medical query is based on an additional medical information item from the medical guideline file. The additional medical information item may be related to the original medical information item, but may nevertheless differ in certain aspects. For example, the two medical information items may relate to two different types of breast cancer, e.g. invasive and noninvasive.

Accordingly, using only one user medical query, e.g., on breast cancer, at least two refined medical queries are generated. Advantageously, a user medical query is refined to provide two refined medical queries that otherwise may not have been combined into a single refined medical query. Advantageously, search results are provided for two different aspects of a user medical query. Advantageously, when the user medical query reflects two different sub-queries, both sub-queries are refined.

It will be appreciated by those skilled in the art that two or more of the above-mentioned embodiments, implementations, and/or aspects of the invention may be combined in any way deemed useful.

Modifications and variations of the workstation, the method, and/or the computer program product, which correspond to the described modifications and variations of the system, can be carried out by a person skilled in the art on the basis of the present description.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for generating a refined medical query from a user medical query and for providing a user with a response to the refined medical query.

FIG. 2 shows a system comprising a receiver for receiving from a usage monitor a medical source and/or a rank associated with the medical source.

FIG. 3 shows a method of generating a refined medical query from a user medical query.

### DETAILED DESCRIPTION OF EMBODIMENTS

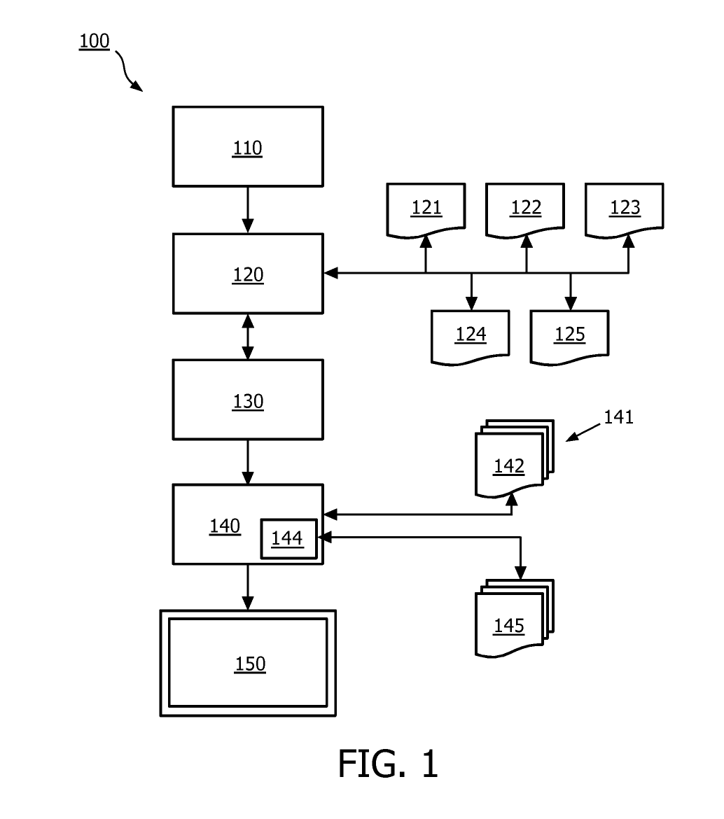

In FIG. 1, a system 100 is shown for providing a user with a response to a user medical query. The system 100 may be built up of a number of blocks. Each block may be partially or completely implemented in software for being executed on a processor. Therefore, the system 100 may comprise a processor for executing instructions from one or more of the blocks. Alternatively, each block may be partially or completely implemented in hardware.

The system 100 comprises an input 110 for receiving the user medical query from the user. The input 110 may be any suitable means for enabling the user to provide the query. For example, the input 110 may be a keyboard for enabling the user to enter the query, or a voice recognizer for enabling the user to speak the query out loud. The input 110 may be an interface connected to a further input means for receiving the query from the user via the further input means. The user medical query typically comprises at least one medical term. For example, a query provided by the user may comprise the medical term “breast cancer” or the more general medical term “cancer”.

The system 100 further comprises an access controller 120 for accessing a medical guideline file 121. The medical guideline file 121 is a computer accessible version of a medical guideline or a medical protocol. For example, the medical guideline file may be a computer accessible version of a medical guideline “Early and locally advanced breast cancer. Diagnosis and treatment”, as published from the National Collaborating Centre for Cancer. The medical guideline file 121 typically comprises at least one medical information item. The medical information item may relate to non-patient specific medical terms or concepts, such as clinical questions, decision options and their outcomes. For example, the medical information item may relate to a possible symptom of breast cancer, e.g., non-mammary pain. Another medical information item may relate to a possible treatment option.

The medical guideline file 121 typically relates to a particular medical domain. The user medical query typically also relates to a particular medical domain. The system 100 may be arranged for determining from the user medical query the medical domain of the user medical query, and then selecting, amongst a plurality of medical guideline files, the medical guideline file 121 that is associated with the medical domain that has been determined from the user medical query. For that purpose, the system 100 may search the user medical query for a keyword that is associated with a medical domain, and then select the medical guideline file 121 in accordance with the medical domain.

The medical guideline file may be organized as a tree or a graph, where each node comprises a state, i.e., a medical information item, and a guard, i.e., a conjunction of conditions. The evaluation of the guard may indicate a branch to be followed in the tree in order to follow a medical guideline or medical protocol. Each such guard may involve a set of medical conditions and thus may need patient information items for evaluation.

The access controller 120 is arranged for accessing a rules repository 122. The rules repository 122 is a computer accessible collection of rules that link medical information items from the medical guideline file to one or more medical terms. For example, the rules repository 122 may comprise a rule linking the medical term “breast cancer symptom” to the medical information item “non-mammary pain”. The rules repository 122 may be a standardized repository, e.g., common for a particular medical domain, or may be customized for a healthcare organization, a clinician or a patient.

A user may also provide a user-defined set of rules which may be stored in the rules repository 122, e.g., in user profiles. This enables the user to customize the system and influence the search results. For example, a clinician may exclude rules that link to a particular set of medical information items from the medical guideline file, e.g., when the clinician is aware that the set of particular medical information items reflects obsolete medical data. Also, the clinician may exclude medical information items relating to, e.g., chemotherapy, when the clinician is aware that a patient refuses that type of treatment.

The access controller 120 may be implemented as a computer file reader, memory controller, internet adapter, or in any other suitable way for accessing the medical guideline file 121 and the rules repository 122.

The system 100 further comprises a query refiner 130 for generating a refined medical query from the user medical query. The query refiner 130 has access to the medical guideline file 121 and the rules repository 122 through the access controller 120. The query refiner 130 may also access other files or sources that the access controller 120 has access to. The user medical query is refined using clinical guidelines and/or disease protocols in the domain of the medical query. For that purpose, the query refiner 130 generates a refined medical query that comprises a medical information item from the medical guideline file 121 that is linked to the user medical term by means of a rule in the rules repository 122.

The refined medical query may be the user medical query, to which the medical information item is added. Thus, the refined medical query may be an enriched or expanded version of the user medical query. The refined medical query may also be the user medical query, in which the user medical term is replaced by the medical information item. Thus, the refined medical query may be a more specific version of the user medical query.

The query refiner 130 may be arranged for generating a plurality of refined medical queries from the user medical query. This may be done by evaluating all possible subgroups of terms in the user medical query, resulting in a plurality of intermediate queries. The plurality of intermediate queries may each be refined in a manner similar to the aforementioned user medical query. Thus, the query refiner 130 may provide a plurality of refined medical queries. Therefore, in addition to the refined medical query, at least one further refined medical query is obtained.

An additional refined medical query may also be obtained from a further rule that links an additional medical information item to the user medical term. For example, when a patient has breast cancer, the medical guideline file 123 may specify therapy options, names of medicines to be prescribed, series of tests to be done. A certain type of disease may be linked in the medical guideline file 123 to several tests, and a specific test result would be linked with a specific therapy plan and specific therapeutic agents. The rules repository may therefore comprise a rule that links the user medical term “breast cancer” to “hormone status”, and a further rule that links “breast cancer” to “prognosis prediction”. Thus, an additional refined medical query may be obtained that includes “prognosis prediction”.

The query refiner 130 may search for the user medical term in the rules repository 122 to find the rule linking the medical information item to the user medical term. The rule that is found provides the query refiner 130 with a link to the medical information item in the medical guideline file 121. The query refiner 130 may access the medical guideline file 121 through the access controller 120 to obtain the medical information item.

The system 100 further comprises a search engine 140 for searching for the refined medical query in a medical data repository 141 to obtain a search result. However, the refined medical query may in itself provide an answer or clarification to the user. Hence, the search engine 140 may then be omitted from the system 100. Instead, the system 100 may comprise an output 150 configured for providing the refined query directly to the user. Alternatively, the system 100 may comprise a data connection for providing the refined medical query to an external search engine. The search engine may be a known search engine, e.g., ‘Google’, for searching a known data repository, e.g., the internet.

The medical data repository 141 shown in FIG. 1 may comprise a wide variety of medical sources. For example, the medical data repository 141 may comprise a medical journal or a medical handbook. Although not shown in FIG. 1, the medical data repository 141 may also comprise the medical guideline file 121 or the patient data file 124. The medical data repository 141 may also comprise a combination of the above examples, i.e., a plurality of medical sources 142.

Instead of comprising the medical sources 142, the medical data repository 141 may also comprise references or links to the plurality of medical sources 142. For searching in the medical data repository 141, the system 100 may locally store the medical data repository. The system 100 may also access the medical data repository 141 through a data connection, e.g., through the internet or a local network connection.

The search engine 140 may be a known search engine, i.e., as is known from the field of internet search engines. The search engine 140 may be arranged for searching for the refined medical query, or the aforementioned plurality of refined medical queries. In the latter case, the search engine 140 may obtain a plurality of search results. The search engine 140 may provide the plurality of search results via the output 150 to the user. The search engine 140 may also provide a subset of said plurality to the user.

The output 150 may be any suitable output for providing the search result to the user. For example, the output 150 may be a display for displaying the search result, or a voice synthesizer for reading the search result out loud to the user. The output 150 may be an interface connected to a further output means for providing the search result to the user via the further output means. In this manner, the user is provided with a response to his medical query.

The access controller 120 may be configured for accessing a medical ontology 123. The medical ontology is a domain-specific representation of medical terms or concepts and their relationship. For that purpose, the medical ontology 123 may be organized as a tree or a graph where each node represents a medical term, and a connection between nodes represents a connection between medical terms. Thus, the nodes may represent medical terms, and their connection may represent their conceptual relationship. The medical ontology 123 may comprise the user medical term and an ontology medical term that is linked to the user medical term. For example, the user medical term and the ontology medical term may be part of the same branch of the medical ontology.

The query refiner 130 may be configured for searching for the user medical term in the medical ontology. The query refiner 130 may then obtain related medical terms by tracing the connections to and/or from the node of the user medical term. Thus, the query refiner 130 may obtain the ontology medical term by tracing a connection from the node of the user medical term to the node of the ontology medical term. The query refiner 130 may be further configured for searching for the ontology medical term in the rules repository 122 to obtain a rule linking a further medical information item to the ontology medical term, and for including the further medical information item in the refined medical query.

Consequently, the query refiner 130 uses the medical ontology 123 to identify other relevant medical terms besides the user medical term, which will then be searched in the medical guideline file 121.

The access controller 130 may be configured for accessing a patient data file 124. The patient data file 124 comprises patient-specific information, i.e., patient information items. Examples of patient data files include a personal health record, an electronic health record, a medication record, etc. The patient data file 124 is typically organized by means of medical information items that identify patient information items, and thus are linked to the patient information items. For example, a medical information item may be “gender”, and the linked patient information item may be “female”. In general, a medical information item may be indicative of a category or portion of the patient data file, and the patient information item may be patient-specific data within the category or portion.

The query refiner 130 may be configured for searching for the medical information item in the patient data file 124 to obtain the patient information item, and for including the patient information item in the refined medical query. Thus, the user medical query is refined by including actual patient data of a particular patient. For example, the patient data file 124 may comprise test results for a hormone status of a patient. Hence, a medical information item “hormone status HER2” may be replaced or expanded with the patient information “HER2 positive” from the patient data file 124. Similarly, “therapeutic agent” may be replaced or expanded with “Herceptin”.

The patient information item may be used for obtaining an additional medical information item for generating an additional refined medical query. As previously stated, the medical guideline file may be organized as a tree or a graph, where each node comprises a state, i.e., a medical information item, and a guard, i.e., a conjunction of conditions. The guard may be related to a result of a medical test. This result may be obtained from a patient information item. Thus, the system 100 may use the patient information item to evaluate the guard, and use the outcome of the evaluation to follow a branch in the tree. The system 100 may then use as the additional medical information item the state of a node that is encountered next while following the branch in the tree.

Consequently, a medical information item from the medical guideline file 123 may be used to obtain a patient information item from the patient data file 124, which may in turn be used to obtain an additional medical information item from the medical guideline file 123. Hence, the medical guideline file 123 and patient data file 124 may be used to generate a refined medical query from the user medical query in an iterative manner.

The access controller 120 may be configured for accessing an attention trail file 125. The attention trail file 125 may comprise an attention information item indicative of a usage of the user of the system 100 or of another system. The usage may include, e.g., previous queries of the user, search results that were read, search results that were not read, etc. The attention trail file may comprise, e.g., a browser cookie.

The query refiner 130 may be configured for including the medical information item in the refined medical query in dependence on the attention information item. Hence, the refinement of the user medical query is performed using the attention information item. For example, the query refiner 130 may be configured for searching for the attention information item in the rules repository 122 to obtain a rule linking to the medical information item. Also, the query refiner 130 may be configured for searching for the attention information item in the medical ontology 123 to obtain the ontology medical term.

As previously stated, the medical data repository 141 may comprise a plurality of medical sources 142. The search engine 140 may comprise a rank manager 144 for accessing a plurality of ranks 145 associated with the plurality of medical sources 142. The system 100 may locally store the plurality of ranks 145. The system 100 may also access the plurality of ranks 145 through a data connection, e.g., through the internet or an intranet. The search engine 140 may be configured for searching for the refined medical query in the plurality of medical sources 142 to obtain a plurality of search results, and selecting at least one of the plurality of search results in dependence on the plurality of ranks 145.

The plurality of ranks 145 may relate to the medical reputation of each of the plurality of medical sources 142. Therefore, the search result may be selected in dependence on the medical reputation of the medical source from which the search result is obtained. The plurality of ranks 145 may relate to other factors that are relevant in the selection of a search result. For example, the plurality of ranks 145 may relate to the age of the medical source, its relevance within a particular medical domain, etc. The plurality of ranks 145 may relate to a combination of the above factors. The output 150 may be configured for providing as the response one or more search results that may have been selected in dependence on the plurality of ranks 145. The output 150 may be configured for combining two or more search results into a single search result, and for providing the single search result to the user.

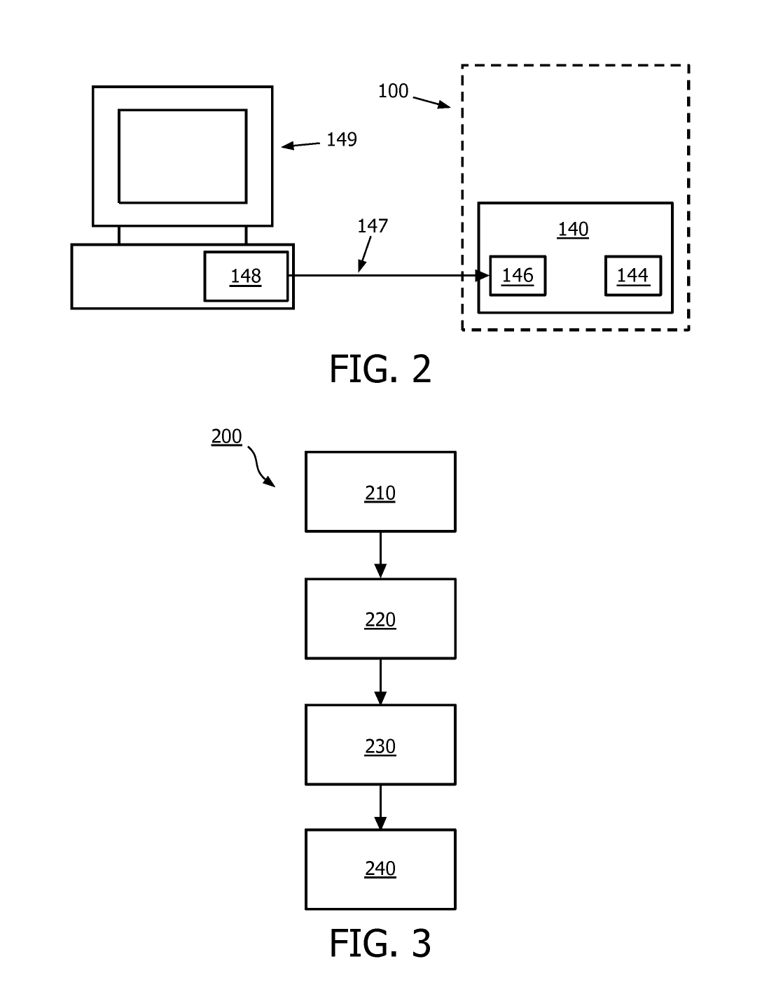

FIG. 2 shows the system 100 with the search engine 140, further comprising a receiver 146 for receiving information 147 from an expert in a medical field of the medical query, said information 147 comprising at least one medical source of the plurality of medical sources 142 and/or at least one rank of the plurality of ranks 145. The information 147 may be received through a data connection, e.g., through the internet or a local network connection. The expert may thus provide expert evaluation of medical sources to rank the search results from said sources in dependence on the quality and relevance of the medical source in a particular domain.

The at least one medical source of the plurality of medical sources 142 and/or the at least one rank of the plurality of ranks 145 may be provided by the expert, using a usage monitor 148 for monitoring a usage, by the expert, of the plurality of medical sources 142. The usage monitor 148 may be, e.g., a software program that is installed on a workstation 149 or computer of the expert. The usage monitor 148 may enable the expert to manually indicate the sites and content he considers relevant and to provide a ranking to those. The usage monitor 148 may also automatically register the sites that are browsed, the articles that are read, the services that are used by experts, etc. Therefore, the at least one of the plurality of medical sources 142 may be automatically provided by the usage monitor 148. Also, the usage monitor 148 may be arranged for receiving input from the expert concerning a quality value related to the content, and for providing the quality value as the at least one of the plurality of ranks 145.

The system 100 may manage experts and pluralities of ranks for all medical domains of interest. Although not shown in FIG. 1 or 2, the system may, for that purpose, comprise a domain experts registry that contains for each medical domain of relevance the experts in that domain that may contribute to the ranking of the plurality of medical sources 142 of that domain. Several levels of expertise may be considered by the system, with each expert belonging to one of those levels. The levels of expertise may be obtained by self-certification, or assessment by other experts. The system 100 may further comprise an experts registry manager, which may register experts in the registries for specific medical domains, and may allow the filling in and updating of the expertise level of the expert. The system may further comprise a domain experts source ranking The domain experts source ranking may collect for each domain the sources/documents/sites/services accessed by the experts and link them to the ranking provided by those experts. When more experts rank a same item, the global rank may be assigned based on a given algorithm, such as average ranking or average ranking weighted by the level of expertise.

FIG. 3 shows a method 200 of generating a refined medical query from a user medical query, the user medical query comprising a user medical term, and the method comprising receiving 210 the user medical query from a user, accessing 220 a medical guideline file and a rules repository, the medical guideline file comprising a medical information item, and the rules repository comprising a rule linking the medical information item to the user medical term, generating 230 the refined medical query from the user medical query by including the medical information item in the refined medical query, and providing 240 the refined medical query to a search engine. Alternatively, step 240 may comprise providing the refined medical query to a user instead of to the search engine.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for generating a refined medical query from a user medical query, the user medical query comprising a user medical term, and the system comprising:
an input for receiving the user medical query from a user;
an access controller for accessing a medical guideline file and a rules repository, the medical guideline file comprising a medical information item, and the rules repository comprising a rule linking the medical information item to the user medical term; and
a query refiner for generating the refined medical query from the user medical query by including the medical information item in the refined medical query and for providing the refined medical query to a search engine, wherein the access controller is configured for accessing an attention trail file, the attention trail file comprising an attention information item indicative of a usage of the system by the user, and wherein the query refiner is configured for including the medical information item in the refined medical query in dependence on the attention information item.

2. A system according to claim 1, wherein the query refiner is configured for searching for the user medical term in the rules repository to obtain the rule linking the medical information item to the user medical term.

3. A system according to claim 1, wherein the query refiner is configured for including the medical information item in the refined medical query by replacing the user medical term in the user medical query with the medical information item to obtain the refined medical query.

4. A system according to claim 1, wherein the access controller is configured for accessing a medical ontology, the medical ontology comprising the user medical term and an ontology medical term that is linked to the user medical term, and wherein the query refiner is configured for:
searching for the user medical term in the medical ontology to obtain the ontology medical term;
searching for the ontology medical term in the rules repository to obtain a rule linking a further medical information item to the ontology medical term; and
including the further medical information item in the refined medical query.

5. A system according to claim 1, wherein the access controller is configured for accessing a patient data file, the patient data file (124) comprising the medical information item and a patient information item linked to the medical information item, and wherein the query refiner is configured for:
searching for the medical information item in the patient data file to obtain the patient information item; and
including the patient information item in the refined medical query.

6. (canceled)

7. A system according to claim 1, the system further comprising:
the search engine for searching for the refined medical query in a medical data repository to obtain a search result; and
an output for providing the search result to the user.

8. A system according to claim 7, wherein the medical data repository comprises a plurality of medical sources, wherein the search engine comprises a rank manager for accessing a plurality of ranks associated with the plurality of medical sources, wherein the search engine is configured for:
searching for the refined medical query in the plurality of medical sources to obtain a plurality of search results;
selecting at least one of the plurality of search results in dependence on the plurality of ranks; and wherein
the output is configured for providing the at least one of the plurality of search results to the user.

9. A system according to claim 8, wherein the search engine further comprises a receiver for receiving from an expert in a medical field of the medical query at least one of the plurality of medical sources and/or at least one of the plurality of ranks.

10. A system according to claim 9, wherein the at least one of the plurality of medical sources and/or the at least one of the plurality of ranks is provided by the expert using a usage monitor for monitoring a usage, by the expert, of the plurality of medical sources.

11. A workstation comprising the system according to claim 1.

12. A method of generating a refined medical query from a user medical query, the user medical query comprising a user medical term, and the method comprising:
receiving the user medical query from a user;
accessing a medical guideline file and a rules repository, the medical guideline file comprising a medical information item, and the rules repository comprising a rule linking the medical information item to the user medical term;
generating the refined medical query from the user medical query by including the medical information item in the refined medical query, wherein an attention trail file comprising an attention information item indicative of a usage of the medical guideline file by the user is accessed, and wherein the medical information item is included in the refined medical query in dependence on the attention information item; and
providing the refined medical query to a search engine.

13. A computer program product comprising instructions for causing a processor system to perform the method according to claim 12.
